(19) United States
(12) Patent Application Publication
(10) Pub. No.: US 2008/0086888 A1
(43) Pub. Date: Apr. 17, 2008

(54) Razor blades comprising a layer including releasable bioactive agent

(76) Inventor: Noah Scheinfeld, Long Beach, NY (US)

Correspondence Address: KLARQUIST SPARKMAN, LLP, 121 SW SALMON STREET, SUITE 1600, PORTLAND, OR, 97204, US

(21) Appl. No.: 11/546,731

(22) Filed: Oct. 11, 2006

(51) Int. Cl. B26B 21/58; B26B 19/38

(52) U.S. Cl. 30/41; 30/346.53

(57) ABSTRACT

Razor blades and other shaving implements are disclosed that include a blade substrate having first and second major surfaces and first and second edges of which at least one edge is configured as a cutting edge. At least one of the major surfaces includes a region that includes at least one polymer carrying at least one bioactive agent in a manner such that use of the blade for shaving an area of skin causes release of the bioactive agent onto the area of skin. The bioactive agent can be, e.g., at least one skin-medicament and/or at least one skin-care agent, or mixtures thereof. The bioactive agent is released in real time, relative to shaving, onto the skin so as to exert its effect as soon as possible on the skin area.

### FIELD

This disclosure relates to, inter alia, improved hair-cutting devices, notably razor blades and analogous implements having a surface at least part of which is coated with or otherwise bearing a composition comprising at least one degradable polymer and at least one bioactive agent, wherein the at least one bioactive agent is released from the blade to the skin while hair on the skin is being cut by the razor blade.

### BACKGROUND

A number of skin diseases are either caused or worsened by shaving with a razor blade. On a person's face, conditions such as acne, rosacea, perioral dermatitis, folliculitis, and gram-negative folliculitis are examples of conditions that are worsened by use of a razor blade. Other conditions, such as pseudofolliculitis barbae (“PFB”) and acne keloidales nuchae (“AKN”) commonly affect both the faces and necks of men who shave skin in these areas. With respect to women, a common problem caused by shaving of underarms, legs, and axilla is folliculitis (inflammation of the hair follicle; also called “shaving bumps”).

PFB (also known colloquially as “shaving bumps” or “ingrown hairs”) is particularly difficult to treat. PFB is a chronic, papular, and pustular foreign-body inflammatory skin disorder seen mainly in persons who have curly hair and is worsened by shaving. This condition is seen most frequently in African-American men who shave their beards (the literature indicates that many, if not most, African-American men have some form of PFB). But, PFB affects other members of the population as well. PFB can be so pronounced in some persons that shaving is impossible. These types of shaving bumps are treated most commonly with topical erythromycin or clindamycin. But, the condition can be persistent, responding only to discontinuing shaving, which is often cosmetically disfavored (e.g., in the army where a soldier must be clean-shaven at all times). Other treatments of PFB include benzoyl peroxide, sulfur leave and wash products, tretinoin, tazarotene, and adaplene. These medications are typically applied after or before shaving, rather than contemporaneously with shaving. These and other substances have been attached to strips (“comfort strips”) mounted on a razor cartridge or applied to the skin from a bladder attached to the razor cartridge, as discussed in U.S. Pat. No. 6,964,097.

Other types of shaving bumps and manifestations of folliculitis also occur. For example, women of all races experience shaving bumps, especially women who wax or shave their axillary and/or pubic skin. Shaving bumps can also occur on the legs of women. Shaving bumps are due to abrasions or micro-abrasions (abrasions not apparent to the unaided eye) that occur on the skin due to the act and sequelae of shaving. These types of shaving bumps can be treated with topical erythromycin or clindamycin. But, compliance with the use of topical dermatological medications is a problem. Usage of any product applied to the skin to treat the skin tends to decrease after several months. Hodari et al., “Adherence in Dermatology: A Review of the Last 20 Years,” J. Derm. Treat. 17:136-142, 2006.

AKN is a chronic, scarring folliculitis that most commonly occurs in young African-American men. It most commonly affects the posterior neck and the occipital aspect of the scalp. AKN manifests as follicular, or less commonly, non-follicular papules that coalesce into firm plaques and nodules. The reported prevalence of AKN among people having African ancestry is 1.3-13.7%. In general, AKN's proximate cause is trauma due to abrasion and micro-abrasions to the skin of the neck and scalp caused by use of razor blades. For example, some American males use a straight razor on the rear scalp and the nape of the neck to cut off closely the hair at the rear hair-line. The bare metal of the straight razor causes microscopic injuries that lead the skin to heal with the formation of scars or keloids (scars that extend the original margin of the scar). Keloids are a normal response to injury and are common in African-Americans.

Other shaving-caused conditions are localized pustular eruptions, mostly seen on the face, due to acne vulgaris, rosacea, perioral dermatitis, gram-positive bacterial folliculitis, and gram-negative folliculitis. These conditions can be worsened by shaving, due in part to: (1) rupture of pustules, and/or (2) trauma to the skin (e.g., abrasions or micro-tears of the skin). Similarly, either type of folliculitis can occur on the legs of women who shave their legs.

Treatment of PFB, AKN, and other shaving-related skin conditions is usually performed after the condition develops and is not currently performed in a preventative manner. For example, after PFB has developed, it is usually treated before or after but not during shaving. Even if a medication is applied before shaving, it is usually not applied directly to a skin location that was injured by the razor.

Many types of razor blades, especially disposable types, include one or more “hard” layers that confer corrosion resistance, increase blade strength, enhance blade sharpness, increase the durability of the cutting edge, and/or improve hair-cutting ability. Example hard layers are diamond, amorphous diamond, diamond-like carbon (“DLC”), nitrides, carbides, oxides, and ceramics. A drawback of using such a razor blade to shave hair on human skin is that certain undesirable conditions can result from or be exacerbated by contact of the hard cutting edge of the blade (including metal, ceramic, or hardened carbon) with human skin and hair follicles. The skin damage can be directly visible (e.g., cuts or abrasions) and/or non-visible (e.g., microscopic or micro cuts and abrasions).

### SUMMARY

In view of the foregoing, there is a long-felt but unmet need for devices and methods that apply a bioactive agent, such as a medicament, directly to a skin site during the act of shaving that site using a razor or analogous implement. With devices and methods as disclosed herein, the skin is regularly dosed with an appropriate bioactive agent at sites that are otherwise adversely affected by shaving. Since the bioactive agent is administered contemporaneously with the act of shaving the sites, a preventive regimen is provided that either prevents occurrence of one or more shaving-related skin conditions or at least substantially reduces the severity of the conditions.

Applicant has also discovered that the act of shaving, which men and women do every day, performed contemporaneously with consistent application of a bioactive agent to the shaved area would substantially increase compliance with the use of the bioactive agent.

According to one aspect, razor blades are provided. An embodiment comprises at least one surface (of the first and second major surfaces of the blade) that is coated with a composition comprising a degradable polymer and a bioactive agent. When such a razor blade is applied to the skin, the polymer and the bioactive agent are released from the blade onto the skin at the points of contact of the razor with the skin. Such a razor can be advantageously used by an individual affected with any of various conditions such as PFB, folliculitis, acne, ACN, and razor bumps.

In a representative embodiment, release of the bioactive agent from the razor blade is triggered by pressure applied to the blade, such as pressing the razor against the skin the normal act of shaving.

According to another embodiment, a razor blade comprises a blade substrate having first and second major surfaces and first and second edges of which at least one edge is configured as a cutting edge. At least one of the major surfaces comprises a region comprising at least one polymer carrying at least one bioactive agent in a manner such that use of the blade for shaving an area of skin causes release of the bioactive agent onto the area of skin.

In one embodiment molecules of the bioactive agent can be interspersed in the polymer. In another embodiment the polymer is formulated to elute molecules of the bioactive agent onto the area of skin as the area is being shaved by the razor blade. In yet another embodiment, molecules of the bioactive agent are bonded to the polymer. In this embodiment the polymer can be formulated to degrade upon exposure to a condition encountered in contacting the area of skin during shaving the area using the razor blade, wherein degradation of the polymer yields release of molecules of the bioactive agent.

The cutting typically comprises a tapered region. In one embodiment the region is situated adjacent the tapered region. In another embodiment the region is situated at least partially in the tapered region.

The region can comprise a layer of a primary polymer and a layer of a secondary polymer. In one embodiment the layer of the secondary polymer is situated at least partially on the layer of the primary polymer, wherein the bioactive agent is carried in the layer of the secondary polymer. The secondary polymer can be formulated to degrade upon exposure to a condition encountered in contacting the area of skin during shaving the area using the razor blade, wherein degradation of the secondary polymer yields release of molecules of the bioactive agent. In this and other embodiments the layer of the secondary polymer can be discontinuous on the layer of the primary polymer. In addition or alternatively, the layer of the primary polymer can be discontinuous.

The region can be situated on one major surface of the blade substrate. Alternatively, the region can be situated on both major surfaces of the blade substrate.

The bioactive agent desirably comprises at least one agent selected from the group consisting of skin-medicaments and skin-care agents and mixtures thereof.

According to another aspect, razor assemblies are provided. An embodiment comprises a cartridge configured to receive at least one razor blade, and a razor blade received in the cartridge. In various embodiments of the razor assembly, the razor blade(s) can have any of the features summarized above.

According to yet another aspect, methods are provided for making a shaving implement. An embodiment comprises sharpening at least one edge of a blade substrate to form a razor blade having a cutting edge. In a region of the blade substrate situated at least adjacent the cutting edge, a layer is formed that comprises at least one polymer and molecules of at least one bioactive agent that are releasable from the layer upon contact of the region with an area of skin to be shaved using the razor blade. The blade can be mounted in a cartridge, for example.

According to yet another aspect, methods are provided for shaving an area of skin. An embodiment of such a method comprises providing a razor blade having at least one cutting edge. In a region of the blade substrate situated at least adjacent the cutting edge, a layer is provided that comprises at least one polymer and molecules of at least one bioactive agent that are releasable from the layer. The method also includes contacting the area of skin with the razor blade so as to create a shaving condition including cutting of hair in the area using the razor blade, the shaving condition being suitable for releasing the bioactive agent onto the area of skin as the area is being shaved using the razor blade.

The foregoing and additional features and advantages of the invention will be more readily apparent from the following detailed description, which proceeds with reference to the accompanying drawings.

### BRIEF DESCRIPTION OF THE DRAWINGS

FIG. 1 is a plan view of an embodiment of a razor blade having a single, longitudinal, sharpened edge (e.g., a type of blade that would be mounted in a razor cartridge) and comprising a region, adjacent the edge, including at least one polymer and at least one bioactive agent.

FIG. 2(A) is an end view of the razor blade of FIG. 1.

FIG. 2(B) is an enlargement of a region of FIG. 2(A), within the circle denoted “B” in FIG. 2(A).

FIG. 3 is a plan view of a first exemplary manner in which the secondary layer (including the bioactive agent) on the surface of a razor blade is discontinuous.

FIG. 4 is a plan view of a second exemplary manner in which the secondary layer (including the bioactive agent) on the surface of a razor blade is discontinuous.

FIG. 5 is a plan view of a third exemplary manner in which the secondary layer (including the bioactive agent) on the surface of a razor blade is discontinuous.

FIG. 6 is a schematic view showing molecules of at least one bioactive agent being released from the secondary polymer layer.

### DETAILED DESCRIPTION

### Razors and Razor Blades

A razor is an exemplary implement used for treating the normal human-body function of hair growth. A razor has one or more razor blades typically formed of a suitable substrate material such as stainless steel. A cutting edge is formed on at least one edge of the substrate to form the razor blade. The cutting edge usually has a wedge-shaped configuration (when viewed edgewise) in which the ultimate tip has a radius less than about 1000 angstroms, e.g., about 200-300 angstroms.

Different types of razors exist. A first type is a straight razor that is used by a barber to shave the face and back of the neck of a customer. Straight razors are also used for shaving the rear scalp of many African-American males. A second type is a “razor assembly” that is a commonly used consumer product. A razor assembly is basically a razor cartridge with a handle. The razor cartridge and handle are usually made of plastic. The razor cartridge has at least one slot that holds a respective razor blade. Some razor cartridges can have more than one razor blade. The cartridge is discarded after having been used a number of times. Razor assemblies are commonly used by men to shave their faces and by women to shave their underarms and legs. A third type is any of various razors and the like that are moved over the skin and are powered by electric motors. This third type is also commonly called an electric shaver. A fourth type is the so-called “safety razor” that uses a double-edged blade. Safety razors have been largely replaced by razor assemblies and electric razors.

Many types of razor blades, especially disposable types and types that are provided in razor assemblies, include one or more “hard” layers that confer corrosion resistance, increase blade strength, enhance blade sharpness, increase the durability of the cutting edge, and/or improve hair-cutting ability. Example hard layers are diamond, amorphous diamond, diamond-like carbon (“DLC”), nitrides, carbides, oxides, and ceramics.

### Polymer-Coated Razor Blades

The razors and razor blades as disclosed herein comprise a rigid “blade-substrate” made of stainless steel, carbon steel, ceramic, silicon carbide, or other suitable material that can be formed into a blade or other cutting configuration having a desired size, shape, and thickness and on which a cutting edge can be formed along at least one edge. The blade-substrate can comprise one or more layers hard layers as noted above.

At least a selected region of the blade-substrate is coated with at least one polymer with which are associated molecules of a “bioactive agent” (e.g., skin medicament). The polymer releases the bioactive agent onto an area of skin at a desired rate as the blade is being used for shaving the area of skin. Exemplary polymers include poly(n-butyl methacrylate), poly(ethylene-co-vinyl acetate), vinyl acetate, ethoxyethyl methacrylate, ethyl methacrylate, methacrylic acid, t-butyl methacrylate, poly(alkyl methacrylate). Hence, desirable polymers can be formulated from methacrylate and acrylate monomers, which include both hydrophobic and hydrophilic moieties. The hydrophilic moieties can be particularly useful for enhancing adhesion of the polymer layer to the blade-substrate (which is usually made of a material that is at least partially hydrophilic).

The polymer layer can comprise a single polymer component or multiple polymer components (e.g., a first polymer component and a second polymer component). With respect to a polymer layer comprising multiple polymer components, a first polymer component can be, for example, a polymer having hydrophilic moieties (to enhance adhesion to the blade substrate) and hydrophobic moieties (to enhance bonding thereto of a generally hydrophobic second polymer component). The second polymer component can include hydrophobic moieties (to enhance bonding to the first polymer component) and hydrophilic moieties (by which molecules of a bioactive agent can be bonded to the second polymer component). In these configurations the second polymer component desirably is relatively degradable under shaving conditions compared to the first polymer component. As noted, molecules of the bioactive agent can be attached to (e.g., covalently bonded to) the second polymer component. (Exemplary functional groups that can be used for such attachment are amino groups.) Each act of shaving performed using the blade degrades some of the second polymer component, which results in release of some of the bioactive agent. Thus, the bioactive agent is controllably released from the razor while the first polymer component remains behind on the blade-substrate.

With respect to polymer layers comprising a single polymer component, the polymer can be a generally hydrophilic polymer (that adheres readily to a generally hydrophilic blade-substrate) that provides hydrophilic moieties (e.g., amino groups) or other moieties to which molecules of bioactive agent(s), including hydrophilic bioactive agents, can be attached. Alternatively or in addition, the polymer can include hydrophobic moieties or regions that may be more favorable for the attachment or association of molecules of hydrophobic bioactive agent(s). The polymer component can be made from a single type of monomer or from multiple types of monomers. For example, the polymer can be a block copolymer or a mixed copolymer. The single polymer desirably has a relatively non-degradable portion (that adheres tenaciously to the blade-substrate) and a relatively degradable portion (to which molecules of the bioactive agent are attached) to facilitate controlled release of the bioactive agent from the non-degradable portion under shaving conditions.

As will be understood from the foregoing, the bioactive agent desirably is associated with (or bonded to) the polymer(s) in such a way that molecules of the bioactive agent can be released in a sustained and controlled rate during use of the razor blade under shaving conditions, including multiple discontinuous uses of the razor. One particularly desirable manner of achieving release of the bioactive agent is by application of pressure. Namely, as the razor blade is pressed against the skin in the act of shaving, molecules of the bioactive agent (either alone or attached to units of degraded polymer) are released from the razor blade to the skin at the point of contact of the coated area of the blade with the skin being shaved. Thus, the bioactive agent is delivered to locations on the skin where therapy is most needed, i.e., to skin sites where skin-disease conditions exist or might arise, in time to prevent or at least ameliorate the skin disease.

Various references concern the attachment of molecules to polymers and the application of polymers to surfaces. Examples of these references are U.S. Pat. No. 6,270,788 to Koulik et al., U.S. Pat. No. 4,929,510 to Ruckstein et al., U.S. Pat. No. 4,196,065 to Gaussens et al., and U.S. Pat. No. 6,214,901 to Chudzik et al., all of which are incorporated herein by reference. However, none of these references teaches or suggests the attachment of bioactive agents to razor blades. Also, no known reference teaches or suggests that a bioactive agent attached to a razor blade can be released gradually from the blade during shaving onto a region of skin being shaved, so as to deliver the bioactive agent to the region. Also, no known reference teaches or suggests attaching one or more bioactive agents to a razor blade (or other hair-cutting implement) using a polymer and in a way by which the bioactive agent can be controllably released from the blade during use of the blade for shaving.

Other references are directed to applying polymer layers, including antibacterial or anti-proliferative agents, to objects that are implanted in a living body. Examples of these other references are U.S. Pat. No. 7,063,884 to Hossainy et al., U.S. Pat. No. 6,869,443 to Buscemi et al., U.S. Pat. No. 6,878,160 to Gilligan et al., U.S. Pat. No. 6,887,270 to Miller et al., U.S. Pat. No. 6,887,485 to Fitzhugh et al., U.S. Pat. No. 6,890,546 to Mollison et al., U.S. Pat. No. 6,899,731 to Li et al., U.S. Pat. No. 6,926,919 to Hossainy et al., and U.S. Pat. No. 7,094,256 to Shah et al., all of which are hereby incorporated by reference.

Various embodiments of shaving implements comprise at least one razor blade or other hair-cutting component (generally termed a “blade”). The razor blade(s) can be mounted in a cartridge or the like or in another type of blade holder, or used without a holder. The blade has at least one region (normally a region that contacts the skin during shaving) coated with at least one primary layer and at least one secondary layer. Each primary layer comprises a respective polymer that can be the same polymer in each layer. Alternatively, the primary layer can be a single layer comprising a respective polymer or polymers (termed “primary polymers”). Each secondary layer comprises a respective polymer(s) that can be the same polymer(s) in each layer. Alternatively, the secondary layer can be a single layer comprising a respective polymer or polymers (termed “secondary polymers”). The primary layer(s) is applied to the blade at least in the region, and is formulated to adhere to the blade-substrate of the blade without interfering with the cutting function of the razor blade. The primary layer(s) can be applied over the entire surface of the blade or over selected region(s) of the blade. The secondary layer(s) is applied to the primary layer(s). The secondary layer can be applied over the entire primary layer(s) or over selected region(s) of the blade. The secondary layer is formulated to hold molecules of the bioactive agent (e.g., by covalent bonds, hydrophobic bonds, Van der Vaal's forces, or other means). By way of example, a single secondary layer can comprise multiple secondary polymers each providing a respective different rate of elution of the bioactive agent. Alternatively, multiple secondary layers can comprise respective secondary polymer(s) providing different respective rates of elution of the bioactive agent.

It is expected that the subject razor will be exposed repeatedly to liquids. For example, razors frequently are used in the shower by women to shave their legs, and razors used by men to shave the face are usually repeatedly rinsed with water during shaving. In one embodiment, the bioactive agent in the secondary layer (or degraded-polymer units comprising the bioactive agent) is released from the razor whenever pressure is applied to the region on the razor where the secondary layer is present, i.e., whenever the razor is pressed against the skin. The secondary polymer(s), due to its structure and/or its incorporation of a release retardant, facilitates the controlled, gradual release of the bioactive agent.

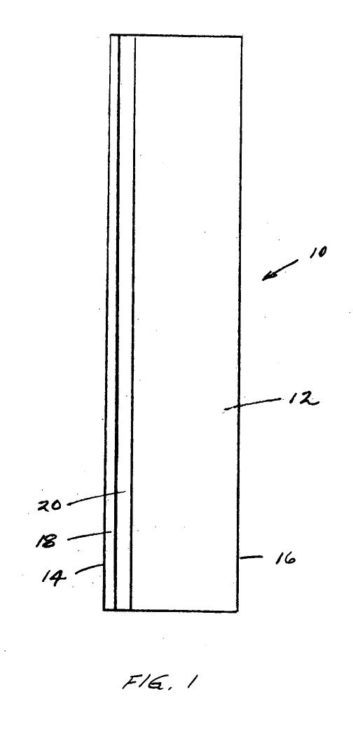

FIG. 1 depicts a representative razor blade 10, comprising a blade substrate 12, a first edge 14, and a second edge 16. In this embodiment the first edge 14 has a tip radius of less than 2,000 angstroms, more desirably 100 to 500 angstroms. To achieve such sharpness, a tapered zone 18 extends along the first edge 14. Adjacent the first edge 14 is a treated zone 20 comprising, in this embodiment, the primary layer and the secondary layer. The treated zone 20 can extend laterally to the left (in the figure) so as to cover some or all the tapered zone 18.

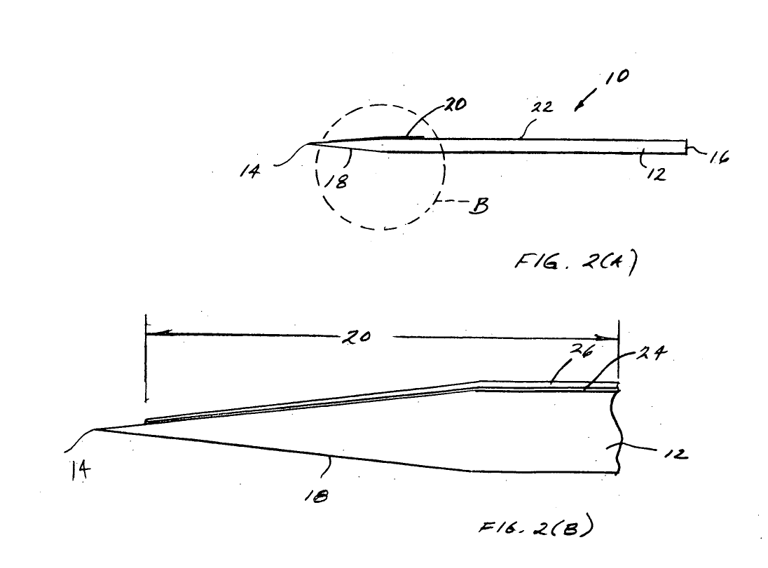

Referring now to FIGS. 2(A)-2(B), certain details of the blade 10 are shown, including the first edge 14, the second edge 16, the tapered zone 18, and the treated zone 20. In this embodiment the treated zone 20 extends into the tapered zone and partially onto an untreated area 22 of the blade 10. The treated zone 20 includes a primary layer 24 and a secondary layer 26. The primary “layer” 24 itself can comprise a single layer of the respective polymer or alternatively can comprise multiple sub-layers (not detailed), such as sub-layers containing respective polymers. The sub-layers need not be co-extensive in the primary layer 24; one sub-layer can cover more of the blade than the other sub-layer.

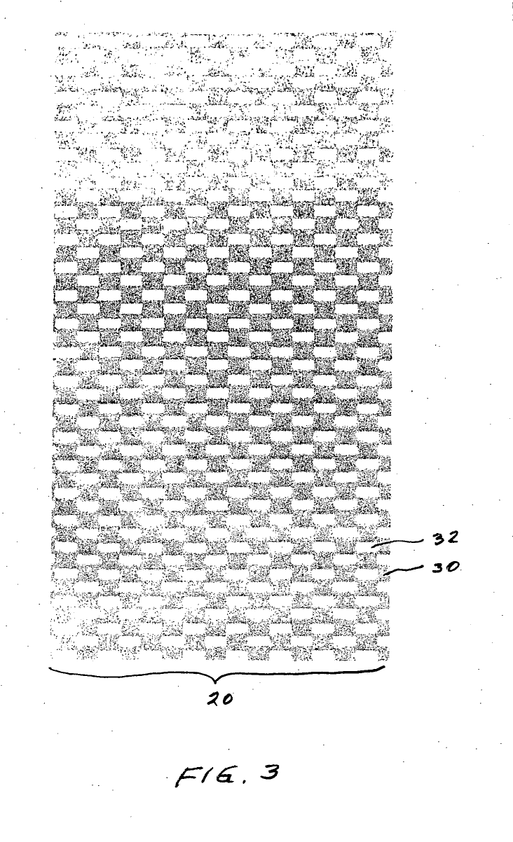

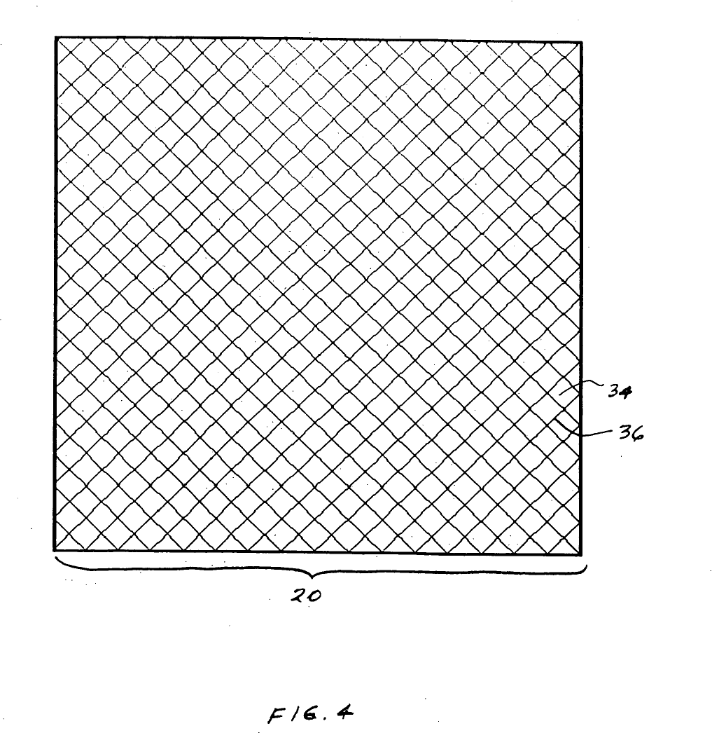

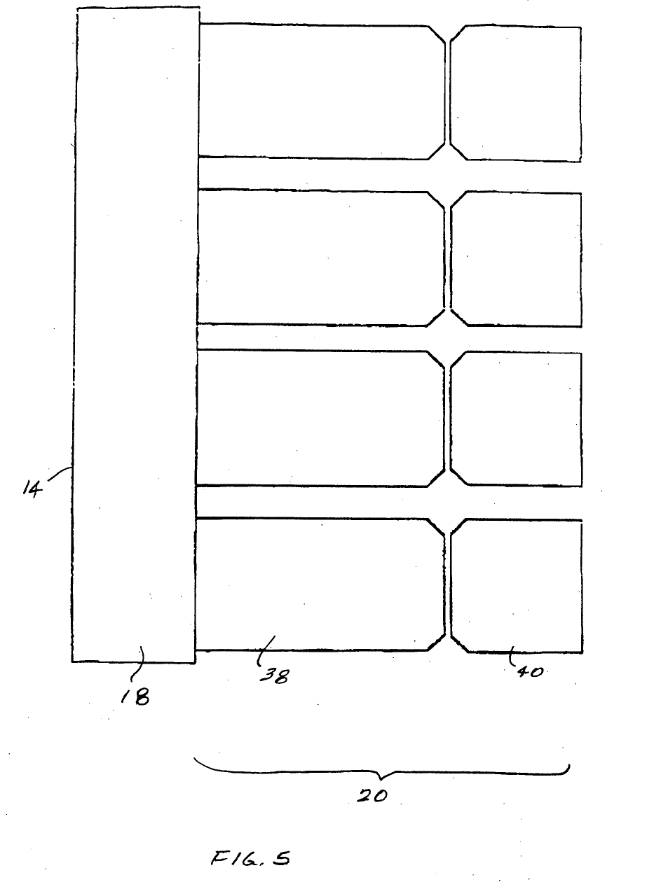

The primary layer 24 and secondary layer 26 can be co-extensive on the blade 10, as shown. But, neither the primary layer 24 nor the secondary layer 26 need cover the entire surface of the blade 10 (although one, such as the primary layer 24, or both these layers can cover the entire blade if desired). As another example, the primary layer 24 can cover more of the blade than the secondary layer 26. Also, one or both these layers 24, 26 can be continuous or discontinuous as desired. For example, the primary layer 24 can be continuous, and the secondary layer(s) can be discontinuous according to a selected pattern. FIG. 3 depicts an exemplary embodiment of a discontinuous secondary layer 30 (shaded regions) and continuous primary layer 32 (unshaded regions) in a treated zone 20. FIG. 4 depicts another exemplary embodiment of a treated zone 20 comprising a continuous primary layer 34 and a discontinuous secondary layer 36. The secondary layer 36 is configured as a matrix of lines in this embodiment. FIG. 5 depicts yet another exemplary embodiment in which both the primary layer 38 and the secondary layer 40 are discontinuous. In this embodiment the treated zone 20 is situated outside the tapered zone 18.

Various embodiments provide different respective mechanisms by which the bioactive agent is released from the razor blade onto the skin being shaved. Basically, the various embodiments release the bioactive agent by normal pressure of the blade against the skin and the accompanying friction of the blade against the skin. One or more additional factors may contribute to the release. For example, in one embodiment, water applied to the razor, along with the pressure and friction, trigger release of secondary-polymer units (molecular fragments, microscopic particles, or the like) containing the bioactive agent. In another embodiment the razor is attached to or at least thermally coupled to a heating unit that heats the blade. Energizing the heating unit results in heating of the razor blade to a temperature that activates and triggers the polymer to degrade, wherein simultaneous application of pressure and friction to the heated blade in the normal act of shaving results in release of the bioactive agent (and any degraded polymer) onto the skin. An alternative embodiment is configured to degrade the secondary polymer and release the bioactive agent only upon contact with a surface at normal body temperature. In yet another embodiment, the razor blade is associated with a shaver or razor assembly that comprises or is energized with an electrical unit that passes a small electrical current (physiologically insignificant and at a physiologically insignificant voltage) through the blade. Passage of the current through the blade triggers degradation of the secondary polymer to release the bioactive agent (and any degraded polymer) onto the skin as the blade is being pressed against the skin in the normal act of shaving. In yet another embodiment release of the bioactive agent (with or without any degraded polymer) is controlled by a microprocessor-equipped shaver assembly (that, for example, delivers a small current to the polymer layer) according to preprogrammed criteria. In yet another embodiment friction and pressure alone activate and trigger conversion of the polymer in the layer to a form that yields release of the bioactive agent to the region of skin being shaved.

In other embodiments, the primary and secondary layers are applied to a straight razor specifically to supply a bioactive agent(s) to a region of skin, currently being shaved, in response to the presence (or possible future incidence) in the region of AKN (e.g., on the back of a person's neck). For example, the bioactive agent can comprise a medicament that targets AKN in the region, and can be effectively administered by the sufferer of this disease or by another person such as the person's barber, simply by shaving the region. This embodiment is of particular utility for shaving the rear scalp where AKN usually develops, especially in response to the trauma of shaving abrasions. A straight razor is not held in a cartridge during use and is much broader than razors typically used by consumers on their faces. Thus, a straight razor is configured that comprises a region coated with a primary polymer and with a secondary polymer containing molecules of the bioactive agent that are released over time from the secondary polymer for application of the bioactive agent to a site being shaved on the skin.

The secondary polymer(s), comprising the bioactive agent(s) desirably is formulated to degrade (break down) into smaller units (molecular fragments of the secondary polymer and/or microscopic particles of the secondary polymer) upon application of a degrading influence, as discussed above. The smaller units contain one or more molecules of the bioactive agent. Alternatively or in addition, the bioactive agent itself can be polymeric in the secondary layer, wherein the bioactive agent is formulated to degrade or erode into smaller, more diffusible, units upon application of the degrading influence. In either instance, degradation results in release of the bioactive agent onto the skin being shaved.

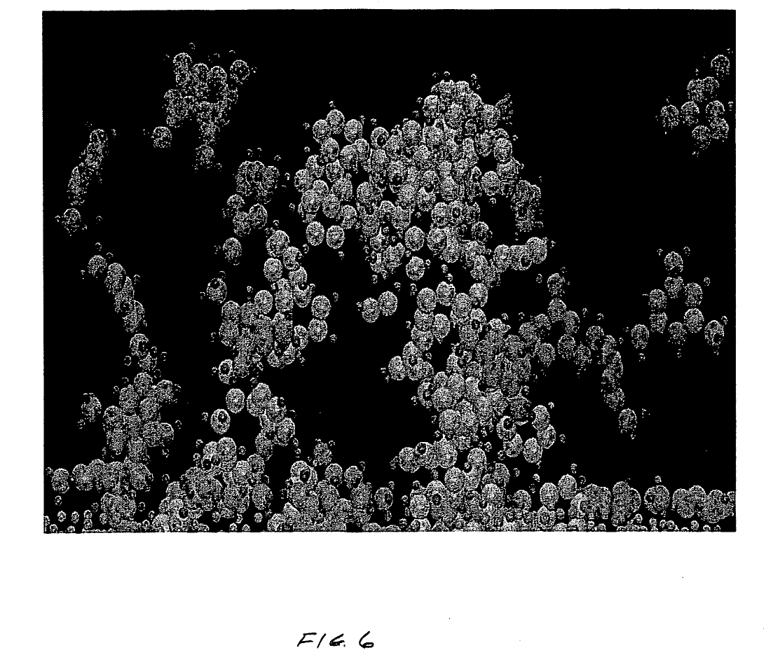

A schematic depiction of the release of a bioactive agent is shown in FIG. 6, in which the secondary polymer is depicted in blue and the bioactive agent is shown in yellow. Application of friction causes breakup of the secondary polymer into units of the secondary polymer, accompanied by elution of the bioactive agent.

Primary and secondary polymers can be selected from (but are not limited to) the following group: t-butyl methacrylate, n-butyl methacrylate, vinyl acetate, ethoxyethyl methacrylate, ethyl methacrylate, and methacrylic acid. Additional examples of these polymers include polymers containing or comprising D-lactic acid, L-lactic acid, racemic lactic acid, glycolic acid, and polycaprolactone. In certain embodiments the primary polymer(s) is hydrophobic and the secondary polymer(s) is hydrophilic.

Exemplary hydrophilic polymers include (but are not limited to): polyurethanes, polyvinylpyrrolidones, polyvinyl alcohols, polyethylene glycols, polypropylene glycols, polyoxyethylenes, polyacrylic acid, polyacrylamide, carboxymethyl cellulose, cellulose, dextrans, polysaccharides, starches, guar, xantham and other gums, collagen, gelatins, biological polymers, and mixtures and copolymers thereof.

Exemplary hydrophobic polymers include (but are not limited to): polytetrafluoroethylene, polyvinyl chloride, polyvinylacetate, poly(ethylene terephthalate), silicone, polyesters, polyamides, polyureas, styrene-block copolymers, polymethyl methacrylate, polyacrylates (e.g., poly(methyl methacrylate), poly(ethyl methacrylate), poly(butyl methacrylate), poly(ethyl methacrylate-co-butyl methacrylate), poly(2-hydroxyethyl methacrylate), poly(methyl methacrylate-co-2-hydroxyethyl methacrylate) and poly(butyl methacrylate-co-2-hydroxyethyl methacrylate)), acrylic-butadiene-styrene copolymers, polyethylene, polystyrene, polypropylene, natural and synthetic rubbers, acrylonitrile rubber, and mixtures and copolymers thereof.

Other candidate polymers (some of which being hydrophilic and others being hydrophobic) include: poly(hydroxyvalerate), poly(L-lactic acid), polycaprolactone, poly(lactide-co-glycolide), poly(hydroxybutyrate), poly(glycerol-sebacate), poly(hydroxybutyrate-co-valerate), polydioxanone, polyorthoester, polyanhydride, poly(glycolic acid), poly(D,L-lactic acid), poly(glycolic acid-co-trimethylene carbonate), polyphosphoester, polyphosphoester urethane, poly(amino acids), cyanoacrylates, poly(trimethylene carbonate), poly(iminocarbonate), co-poly(ether-esters) (e.g., PEO/PLA), polyalkylene oxalates, polyphosphazenes, biomolecules (e.g., fibrin, fibrinogen, cellulose, starch, collagen, and hyaluronic acid), silicones, polyesters, polyolefins, polyisobutylene and ethylene-α-olefin copolymers, vinyl halide polymers and copolymers (e.g., polyvinyl chloride), polyvinyl ethers (e.g., polyvinyl methyl ether), polyvinylidene chloride, polyacrylonitrile, polyvinyl ketones, polyvinyl aromatics (e.g., polystyrene), polyvinyl esters (e.g., polyvinyl acetate), copolymers of vinyl monomers with each other and olefins (e.g., ethylene-methyl methacrylate copolymers, acrylonitrile-styrene copolymers, ABS resins, and ethylene-vinyl acetate copolymers), polyamides (e.g., Nylon 66 and polycaprolactam), alkyd resins, polycarbonates, polyoxymethylenes, polyimides, polyethers, epoxy resins, polyurethanes, rayon, rayon-triacetate, cellulose, cellulose acetate, cellulose butyrate, cellulose acetate butyrate, cellophane, cellulose nitrate, cellulose propionate, cellulose ethers, carboxymethyl cellulose, fluorinated polymers and/or copolymers (e.g., poly(vinylidene fluoride), “PVDF”) and poly(vinylidene fluoride-co-hexafluoropropene), “PVDF-HFP”), and blends of polyacrylates and fluorinated polymers and/or copolymers.

Any of various techniques can be used to apply primary and secondary polymers to a surface of a razor. Application of these polymers can be generally the same, except that the preparation of the primary polymer for application to the blade usually does not (but can if desired) include the bioactive agent(s). The following examples specifically describe application of the secondary polymer.

A particularly desirable general technique involves direct application of the polymer, in a suitable carrier, onto the surface of a razor. Absolution is prepared that includes a liquid solvent (as the carrier) and the polymer(s) dissolved in the solvent to yield a polymer solution. The polymer can include molecules of the bioactive agent bonded to the polymer. Alternatively, depending upon the particular bioactive agent, the bioactive agent(s) can be dissolved in the solution or dispersed in the solution. The resulting preparation is applied directly to the razor such as by dipping, painting, printing, or spraying. The solvent is allowed to evaporate or is otherwise driven off, leaving on the razor surface a coating of the polymer with the bioactive substance bonded to or impregnated in the secondary polymer. This technique works especially well with polymers that are thermoplastics.

Another technique is to prepare a liquid solution or dispersion of the polymer(s) and bioactive agent(s) that is applied to the razor surface, followed by application of heat or other curing stimulus to “cure,” or rigidify, the polymer. In this regard, it is noted that rigidification by curing need not proceed to absolute hardness of the polymer; with certain cured polymers, some compliance is normal. As noted, the curing stimulus can be heat; alternative curing stimuli (depending upon the particular polymer) include, for example, application of an electron beam, application of X-ray light, application of ultraviolet light, application of visible light, exposure to a gas (e.g., under elevated pressure), application of microwave energy, and application of a liquid chemical curing catalyst. These alternative curing methods are usually termed “cold-curing” methods. This technique is especially applicable to polymers that are thermosets, wherein the curing stimulus results in further polymerization and/or cross-linking.

Various approaches can be exploited to ensure that the primary polymer remains attached to the blade as the bioactive agent (with or without the secondary polymer) is released onto the skin. For example, in some embodiments the secondary polymer is formulated to be more unstable in the presence of pressure, heat, electrical current, friction, and/or other local applications of energy than the primary polymer. Consequently, the secondary polymer can be released by degradation, upon local application of energy to the secondary polymer, to the skin being shaved by the razor. The primary polymer remains attached to the razor because it is stable in the presence of the energy being applied to the razor. As noted, degradation of the secondary polymer is accompanied by release of the bioactive agent. Alternatively, especially in configurations in which the bioactive agent is merely dispersed or intercalated in the matrix formed by the secondary polymer, application of energy simply causes release of the bioactive agent from the matrix.

In one embodiment, the primary polymer has a hydrophobic component and a hydrophilic component, wherein a region of the secondary polymer has a higher content or concentration of the hydrophilic component than of the hydrophobic component and thus is more readily released.

Whereas, in the embodiments discussed above, the secondary polymer(s) and bioactive agent(s) are simply coated on a region of the surface of the razor blade, it is also contemplated that this region can be situated in a channel, groove, or depression in the surface of the blade adjacent the cutting edge of the blade. Placing the secondary polymer(s) and bioactive agent(s) in a channel can be effective in achieving a controlled rate of release of the bioactive agent(s). Also, whereas the various embodiments discussed above have the region of secondary polymer(s) and bioactive agent(s) on a single major surface of the razor blade, it is also possible to have such regions located on both major surfaces (“front” and “back”) of the razor blade. Also, on one or both major surfaces of the blade, the region can be a single respective region or multiple regions, e.g., two regions separated by an uncoated region.

“Bioactive agents” as used herein encompass any of various medicaments and/or any of various “skin-care” agents. Exemplary bioactive agents include (but are not limited to): immunostimulants, antiviral agents, sulfur-containing agents, antikeratolytics, anti-inflammatories, antifungals, acne-treating agents, sunscreens, dermatological agents, antihistamines, antibacterials, bioadhesives, respiratory-bursting inhibitors, inhibitors of prostaglandin synthesis, antimicrobials, antiseptics, anaesthetics, cell-nutrient media, burn-relief medications, sunburn medications, insect-bite and sting medications, wound cleansers, wound dressings, scar-reducers, and mixtures thereof. medications, wound cleansers, wound dressings, scar-reducers, oligopeptides able to stimulate fibroblasts, oligopeptides able to inhibit fibroblasts, onion or other fruit, vegetable or plant extracts, and mixtures thereof.

Exemplary skin-care agents include (but are not limited to) one or more of the following: alcohol, α-hydroxy acid, β-hydroxy acid, benzoyl peroxide, resorcinol and its derivatives, salicylic acid, hydrogen peroxide, sulfur, eflomithine, antiandrogens, corticosteroids, hydrochloride, erythromycin, clindamycin, tetracycline, isotretinoin and its derivatives, tretinoin, tazarotene, adaplene, chaparral, dandelion root, licorice root, echinacea, kelp, cayenne, sassafras, elder flowers, pantothenic acid, p-aminobenzoic acid, biotin, choline, inositol, folic acid, calcium, magnesium, potassium, and derivatives thereof in amounts sufficient to enhance, in a synergistic manner the treatment of acne, folliculitis, AKN, or PFB, for example.

Particularly desirable bioactive agents are selected for their efficacy in mitigating or preventing the development of papules and bump-like lesions that are indicative of PFB, acne, and razor bumps. Such bioactive agents function both in the treatment and in the prevention/mitigation of diseases, principally of the skin, caused or aggravated by shaving. In any event, the bioactive agent in released locally, in real time, onto the skin being shaved. Local delivery in this manner is desirable because the delivered bioactive agent is concentrated at specific sites that can benefit from it. Local delivery thus produces fewer side-effects and achieves more favorable results.

The secondary polymer can contain release retardants that allow the gradual release of the secondary polymer with each application to the skin.

Various embodiments can be configured as single-use razors, multiple-use razors, single-blade razors, multiple-blade razors, safety razors, or electric razors. Other embodiments include the polymer layer attached to any of various other cutting implements such as scissors. Conventional wet-shaving systems contain a re-usable frame including a handle, as well-known in the art. The frame is configured to receive a disposable blade cartridge containing one or more blades. If more than one blade is used, then at least one of the blades (desirably all the blades) can include the bioactive agent as disclosed herein. Spent cartridges are removed from the frame and replaced by fresh cartridges as needed.

The various configurations of razors and other hair-cutting implements as disclosed herein will bring relief and general health benefits to a wide range of people, including through mass-marketed consumer goods such as improved razors.

Whereas the invention has been described above in connection with multiple representative embodiments, it is not limited to those embodiments. On the contrary, the invention is intended to encompass all modifications, alternatives, and equivalents as may be included within the spirit and scope of the invention, as set forth in the following claims.

What is claimed is:

1. A razor blade, comprising:
a blade substrate having first and second major surfaces and first and second edges of which at least one edge is configured as a cutting edge; and
at least one of the major surfaces comprises a region comprising at least one polymer carrying at least one bioactive agent in a manner such that use of the blade for shaving an area of skin causes release of the bioactive agent onto the area of skin.

2. The razor blade of claim 1, wherein molecules of the bioactive agent are interspersed in the polymer.

3. The razor blade of claim 2, wherein the polymer is formulated to elute molecules of the bioactive agent onto the area of skin as the area is being shaved by the razor blade.

4. The razor blade of claim 1, wherein molecules of the bioactive agent are bonded to the polymer.

5. The razor blade of claim 4, wherein:
the polymer is formulated to degrade upon exposure to a condition encountered in contacting the area of skin during shaving the area using the razor blade; and
degradation of the polymer yields release of molecules of the bioactive agent.

6. The razor blade of claim 5, wherein the condition is shaving pressure exerted by the razor blade against the area of skin.

7. The razor blade of claim 1, wherein:
the cutting edge comprises a tapered region; and
the region is situated adjacent the tapered region.

8. The razor blade of claim 1, wherein:
the cutting edge comprises a tapered region; and
the region is situated at least partially in the tapered region.

9. The razor blade of claim 1, wherein:
the region comprises a layer of a primary polymer and a layer of a secondary polymer;
the layer of the secondary polymer is situated at least partially on the layer of the primary polymer; and
the bioactive agent is carried in the layer of the secondary polymer.

10. The razor blade of claim 9, wherein:
the secondary polymer is formulated to degrade upon exposure to a condition encountered in contacting the area of skin during shaving the area using the razor blade; and
degradation of the secondary polymer yields release of molecules of the bioactive agent.

11. The razor blade of claim 10, wherein the layer of the secondary polymer is discontinuous on the layer of the primary polymer.

12. The razor blade of claim 11, wherein the layer of the primary polymer is discontinuous.

13. The razor blade of claim 1, wherein the region is situated on one major surface of the blade substrate.

14. The razor blade of claim 1, wherein the region is situated on both major surfaces of the blade substrate.

15. The razor blade of claim 1, wherein the bioactive agent comprises at least one agent selected from the group consisting of skin-medicaments and skin-care agents and mixtures thereof.

16. A razor assembly, comprising:
a cartridge configured to receive at least one razor blade; and
a razor blade received in the cartridge, the razor blade comprising a blade substrate having first and second edges of which at least one edge is configured as a cutting edge, the blade substrate comprising a region comprising at least one polymer carrying at least one bioactive agent, the region being situated such that use of the razor assembly for shaving an area of skin causes contact of the region with the area of skin and release of the bioactive agent onto the area of skin.

17. The razor assembly of claim 16, wherein molecules of the bioactive agent are interspersed in the polymer.

18. The razor assembly of claim 17, wherein the polymer is formulated to contact the area of skin and release molecules of the bioactive agent onto the area of skin as the area is being shaved by the razor assembly.

19. The razor assembly of claim 16, wherein molecules of the bioactive agent are bonded to the polymer.

20. The razor assembly of claim 19, wherein:
the polymer is formulated to degrade upon exposure to a condition encountered in contacting the area of skin during shaving the area using the razor assembly; and
fragmentation of the polymer yields release of molecules of the bioactive agent onto the area of skin being shaved by the razor assembly.

21. The razor assembly of claim 16, wherein:
the cutting edge comprises a tapered region; and
the region is situated adjacent the tapered region or at least partially overlapping the tapered region.

22. The razor assembly of claim 16, wherein:
the region comprises a layer of a primary polymer and a layer of a secondary polymer;
the layer of the secondary polymer is situated at least partially on the layer of the primary polymer; and
the bioactive agent is carried in the layer of the secondary polymer.

23. The razor assembly of claim 22, wherein:
the secondary polymer is formulated to degrade upon exposure to a condition encountered in contacting the area of skin during shaving the area using the razor assembly blade; and
degradation of the secondary polymer yields release of molecules of the bioactive agent onto the area of skin.

24. The razor assembly of claim 23, wherein the layer of the secondary polymer is discontinuous on the layer of the primary polymer.

25. A method for making a shaving implement, comprising:
sharpening at least one edge of a blade substrate to form a razor blade having a cutting edge;
in a region of the blade substrate situated at least adjacent the cutting edge, forming a layer comprising at least one polymer and molecules of at least one bioactive agent that are releasable from the layer upon contact of the region with an area of skin to be shaved using the razor blade.

26. The method of claim 25, further comprising mounting the razor blade in a cartridge.

27. A method for shaving an area of skin, comprising:
providing a razor blade having at least one cutting edge;
in a region of the blade substrate situated at least adjacent the cutting edge, providing a layer comprising at least one polymer and molecules of at least one bioactive agent that are releasable from the layer; and
contacting the area of skin with the razor blade so as to create a shaving condition including cutting of hair in the area using the razor blade, the shaving condition being suitable for releasing the bioactive agent onto the area of skin as the area is being shaved using the razor blade.
